(19) United States
(12) Patent Application Publication
(10) Pub. No.: US 2011/0133134 A1
(43) Pub. Date: Jun. 9, 2011

(54) Crosslinkable and Crosslinked Compositions of Olefin Polymers and Graphene Sheets

(75) Inventors: Vipin Varma, Gent (BE); Dan Scheffer, Frederick, MD (US)

(73) Assignee: VORBECK MATERIALS CORP., Jessup, MD (US)

(21) Appl. No.: 12/797,595

(22) Filed: Jun. 9, 2010

Related U.S. Application Data
(60) Provisional application No. 61/185,228, filed on Jun. 9, 2009.

(51) Int. Cl. H01B 1/24; C08L 23/02; C08L 61/00; C08L 33/06; C08L 29/04; C08K 3/04; C08L 23/26; C08L 33/02; C08L 31/04; B05D 3/02

(52) U.S. Cl. 252/511; 524/580; 524/543; 524/556; 524/557; 524/495; 524/576; 524/563; 427/385.5

(57) ABSTRACT

Compositions comprising graphene sheets, at least one olefin polymer, and at least one crosslinking agent and crosslinked compositions comprising graphene sheets and at least one olefin polymer. A method of making a crosslinked composition comprising graphene sheets and at least one olefin polymer, coatings comprising the compositions, and a method of coating a surface with the compositions are disclosed.

### RELATED APPLICATIONS

This application claims priority to, and the benefit of U.S. Provisional Patent Application Ser. No. 61/185,228, filed on Jun. 9, 2009, entitled “Crosslinkable and Crosslinked Compositions of Olefin Polymers and Graphene Sheets,” which is incorporated herein by reference in its entirety.

### FIELD OF THE INVENTION

The present invention relates to crosslinkable and crosslinked compositions comprising olefin polymers and graphene sheets. It further related to methods of making a crosslinked composition comprising graphene sheets and at least one olefin polymer and methods of coating a surface with the compositions.

### BACKGROUND

Polymeric compositions are finding increased use in many areas that have traditionally been the domain of other materials such as metals. In part this is because of the physical properties of polymeric materials, their light weight, their cost, etc. Furthermore, many polymeric materials (depending on the characteristics of the particular resin) have the ability to be formed into a wide variety of shapes and forms, including intricate parts and physically flexible forms. Polymeric materials have great flexibility in the forms they can take on and (depending on the characteristics of the particular resin) can be used as molding and extrusion resins, pastes, powders, dispersions, coatings, etc.

Many of the applications for which it would be desirable to use polymer compositions need materials having electrical conductivity. However, most polymeric materials are not intrinsically electrically or thermally conductive enough for some of these applications. Conductive polymeric resin compositions can be made in some cases by adding fillers to polymers, but high loadings are often required, which can be to the detriment of physical and other properties of the materials, as well as lead to melt processing difficulties when thermoplastic materials are used, among other possible drawbacks.

The use of polymer-based coating compositions is particularly desirable in a number of applications, including those where electrical conductivity is desired, as they can not only have cost, weight, processability, and flexibility of design advantages over metals, but can be used in cases where metals would often be impractical, such to make flexible devices (like displays). Carbonaceous materials such as carbon black have been used for to make conductive polymer compositions, including coatings, but in many cases they are insufficiently conductive for many applications or require loadings that are too high and, for example, harm certain desirable physical properties of the materials.

In many cases, the conductive additives have insufficient compatibility with the polymer binder, leading to one or more undesirable effects such as lack of mechanical integrity and/or decreased conductivity. Furthermore, when used as coatings, laminates, or other structures that require adhesion to another article, the compositions are in some cases not able to make a sufficiently strong bond with the material of the second article. This can be a particular problem when the compositions are adhered to a flexible substrate (such as a rubber or elastomers) that is subjected to bending, stretching, twisting, and/or other distortions while in use.

It would thus be desirable to obtain electrically conductive polymer compositions that can be adhered to substrates (such as flexible substrates, for example).

WO 2008/045778 discloses nanocomposites of functional graphene and rubber. U.S. Pat. No. 3,945,877 discloses compositions for making thermoplastic adhesives and coatings that include coal pitch tar and two copolymers of ethylene crosslinked with dicumyl peroxide. U.S. Pat. No. 6,528,550 discloses crosslinked microcellular polymer foam compositions comprising an ethylene vinyl acetate copolymer, an ethylene/acrylic acid copolymer, and a free radical initiator crosslinking agent.

### SUMMARY OF THE INVENTION

Disclosed and claimed herein are compositions comprising graphene sheets, at least one olefin polymer, and at least one crosslinking agent; compositions comprising graphene sheets and a crosslinked olefin polymer; a method of making a composition comprising graphene sheets and at least one substituted olefin polymer; and a method of coating a surface comprising graphene sheets and at least one olefin polymer wherein the olefin polymer is applied to a substrate and crosslinked.

### DETAILED DESCRIPTION OF THE INVENTION

In one embodiment, compositions comprise at least one olefin polymer, graphene sheets, and a crosslinking agent. In another embodiment, the compositions comprise at least one crosslinked olefin polymer and graphene sheets.

The olefin polymers are derived from one or more monomers comprising alkene and/or acetylene groups. Examples of monomers include hydrocarbons, such as ethylene, propylene, butylenes, alpha-olefins, dienes (such as butadiene, norbornadiene, hexadienes, isoprene, etc. and including linear, branched, and alicylic dienes), etc.

Other monomers include compounds having carbon-carbon double and triple bonds substituted with one or more aryl groups and/or heteroatom containing groups. (“substituted unsaturated monomers”). Examples of monomers and substituents include, but are not limited to, vinyl compounds, acrylates, (meth)acrylates, esters, ethers, carboxylic acids, carboxylic acid anhydrides, carboxylic acid salts, ionomers, ketones, aldehydes, acetals, ketals, orthoesters, nitriles, ethers, hydroxyl groups, aromatic groups (such as phenyl and substituted phenyl groups), halogens (such as fluorine, chlorine, bromine, etc.), etc.

Examples of monomers include acrylic acid, (meth)acrylic acid, acrylates (such as methyl acrylate, ethyl acrylate, propyl acrylate, butyl acrylate, etc.), glycidyl acrylate, glycidyl methacrylate, (meth)acrylates (such as methyl (meth)acrylate, ethyl (meth)acrylate, propyl (meth)acrylate, butyl (meth)acrylate, etc.), vinyl ethers (such as divinyl ether, etc.), vinyl esters (such as vinyl acetate, etc.), vinyl alcohol, anhydrides (such as maleic anhydride, etc.), dicarboxylic acids (such as maleic acid, fumaric acid, etc.), mono- and diesters of dicarboxylic acids, fluorinated compounds (such as vinyl fluoride, vinylidene fluoride, fluorinated ethylene propylene (FEP), etc.), acrylonitrile, aryl-substituted vinyl groups (such as styrene and substituted styrenes), chlorinated compounds (such as vinyl chloride, vinylidene chloride, etc.), fluorochloro compounds, etc.

Examples of olefin polymers include those derived from hydrocarbon monomers, those derived from substituted unsaturated monomers, those derived from at least one hydrocarbon monomer and at least one substituted unsaturated monomer having at least one heteroatom-containing substituent, those derived by grafting olefin polymers with at least one substituted unsaturated compound (such as a monomer, including those mentioned above), etc. In one embodiment, at least one or all substituent groups are electron withdrawing groups.

In one embodiment, the olefin polymers are polymers that have been further reacted after they have been polymerized. For example, they may have been reduced, oxidized, hydrogenated, esterified, hydrolyzed, saponified, grafted, etc.

Examples of olefin polymers include polyethylene (including linear low density polyethylene (LLDPE), low density polyethylene (LDPE), high density polyethylene, ultrahigh molecular weight polyethylene (UHMWPE), etc.), polypropylene, olefin copolymers, polystyrene (including high impact polystyrene), acrylonitrile/butadiene/styrene (ABS), styrene/acrylonitrile polymers (SAN), poly(vinyl acetate), ethylene/vinyl acetate copolymers, poly(acrylic acid), ethylene/acrylic acid copolymers, ethylene/acrylic acid/maleic anhydride copolymers, styrene acrylic acid copolymers, propylene/maleic anhydride copolymers, methyl methacrylate polymers, methacrylate copolymers, polymers derived from one or more acrylates, methacrylates, ethyl acrylates, ethyl methacrylates, butyl acrylates, butyl methacrylates, polyvinyl alcohol, poly(vinyl butyral), ionomers (such as carboxyl group containing olefin polymers (including ethylene/acrylic acid copolymers, ethylene/methacrylic acid polymers, etc.) that have been neutralized or partially neutralized with metal cations such as zinc, sodium, lithium, etc.), etc.

The olefin polymers may be rubbers or elastomers. Examples include, but are not limited to, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, etc.

Examples of suitable polymers include Elvacite® polymers supplied by Lucite International, Inc., including, for example, Elvacite® 2009, 2013, 2014, 2016, 2028, 2042, 2045, 2046, 2550, 2552, 2614, 2669, 2697, 2776, 2823, 2895, 2927, 3004, 4018, 4021, 4026, 4028, 4044, 4059, 4400, 4075, 4060, 4102, etc. Other polymer families include Bynel® polymers (such as Bynel® 2022 supplied by DuPont) and Joncryl® polymers (such as Joncryl® 678 and 682).

Crosslinking may be radical crosslinking. Examples of crosslinking agents include free radical initiators. The radical initiators may be activated using any suitable method, such as by heat, by radiation (such as UV radiation, electron beam, etc.), a combination of two or more methods, etc. The olefin polymers are not crosslinked using sulfur or related vulcanization methods.

In some embodiments, thermal crosslinking (such as that done using a radical initator) is preferably done between about 150 and 225° C. or more preferably between about 150 and 185° C.

Thermal cross linking may also be done in stages where, for example, the temperature is held at a certain point for a given period of time and then raised or lowered for another period of time. The temperature may also be ramped during the curing. Thermal and UV radiation cross-linking and/or other methods may be combined.

Radical initiators may include radical polymerization initiators, radical sources, etc., including organic and inorganic compounds. Examples include organic and inorganic peroxides (such as hydrogen peroxide, dialkyl peroxides, hydroperoxides, peracids, diacyl peroxides, peroxy esters, ketone peroxides, hydrocarbon peroxides, organometallic peroxides, organic polyoxides, organic polyoxides, dialkyl trioxides, hydrotrioxides, tetroxides, alkali metal peroxides (such as lithium peroxide), etc.), azo compounds, polyphenylhydrocarbons, substituted hydrazines, alkoxyamines, nitrocompounds, nitrates, nitrites, nitroxides, disulfides, polysulfides, persulfates (e.g. potassium persulfate, etc.), etc.

Examples of peroxides include, but are not limited to dibenzoyl peroxide, dicumyl peroxide, acetone peroxide, methyl ethyl ketone peroxide, lauroyl peroxide, tert-butyl peroxide, tert-butyl peracetate, di-tert-amyl peroxide, tert-butyl hydroperoxide, cumene hydroperoxide, 1,3-bis-(tert-butylperoxy-1-propyl)benzene, bis-(tert-butylperoxy)valerate, bis-(2,4-dichlorobenzoyl)peroxide, etc.

Examples of azo compounds include azobisisobutylonitrile (AlBN); 1,1′-azobis(cyclohexanecarbonitrile) (ABCN); 2,2′-azobis(2-methylbutyronitrile); 2,2′-azobis(2-methylpropionitrile); 2,2′-azobis(2-methylpropionitrile); N-tert-butyl-N-(2-methyl-1-phenylpropyl)-O-(1-phenylethyl)hydroxylamine, etc.

In some embodiments, the initiators are preferably used in about 5 weight percent to about 200 weight percent, or more preferably in about 5 weight percent to about 100 weight percent, or yet more in about 50 weight percent to about 100 weight percent, based on the total weight of olefin polymer.

One or more crosslinking promoters or coagents may be present in the compositions. Examples include multifunctional (e.g. those containing at least two unsaturated radical polymerizable functional groups such as vinyl and other alkenyl groups) small molecules, oligomers, and polymers, etc. These may include, but are not limited to difunctional and trifunctional monomers; polybutadienes (including polybutadiene diacrylates, high vinyl polybutadiene, low molecular weight hydroxyl terminated polybutadienes and their esters, and the like); and diols, glycols, and polyethers (such as 1,4-butanediol, 1,6-hexanediol, poly(ethylene glycols), di(methylene glycol), di(ethylene glycol), di(butylene glycol), tri(propylene glycol), cyclohexanediols, 1,3-butylene glycol, etc.) that are terminated and/or otherwise substituted with two or more unsaturated radical polymerizable groups such as acrylates and methacrylates (examples of which include those manufactured by Sartomer Co., Inc., Exton Pa.). Examples also include di- and triallyl compounds, diacrylates and dimethacrylates, trifunctional (meth)acrylate esters, etc., such as N-N′-m-phenylenedimaleidmide, triallyl cyanurate (TAC), triallyl isocyanurate (TAIC), poly(butadiene)diacrylate, trimethylolpropane tri(meth)acrylate (TMPT), calcium di(meth)acrylate, trimethylolpropane tri(meth)acrylate, etc.

The graphene sheets are graphite sheets preferably having a surface area of from about 100 to about 2630 m²/g. In some embodiments, the graphene sheets primarily, almost completely, or completely comprise fully exfoliated single sheets of graphite (these are approximately 1 nm thick and are often referred to as “graphene”), while in other embodiments, at least a portion of the graphene sheets may comprise at partially exfoliated graphite sheets, in which two or more sheets of graphite have not been exfoliated from each other. The graphene sheets may comprise mixtures of fully and partially exfoliated graphite sheets.

Graphene sheets may be made using any suitable method. For example, they may be obtained from graphite, graphite oxide, expandable graphite, expanded graphite, etc. They may be obtained by the physical exfoliation of graphite, by for example, peeling off sheets graphene sheets. They may be made from inorganic precursors, such as silicon carbide. They may be made by chemical vapor deposition (such as by reacting a methane and hydrogen on a metal surface). They may be may by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc.

Graphene sheets may be made from graphite oxide (also known as graphitic acid or graphene oxide). Graphite may be treated with oxidizing and/or intercalating agents and exfoliated. Graphite may also be treated with intercalating agents and electrochemically oxidized and exfoliated. Graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. Graphene sheets may also be formed by mechanical treatment (such as grinding or milling) to exfoliate graphite or graphite oxide (which would subsequently be reduced to graphene sheets).

Reduction of graphite oxide to graphene sheets may be by means of chemical reduction and may be carried out on graphite oxide in a solid form, in a dispersion, etc. Examples of useful chemical reducing agents include, but are not limited to, hydrazines (such as hydrazine, N,N-dimethylhydrazine, etc.), sodium borohydride, citric acid, hydroquinone, isocyanates (such as phenyl isocyanate), hydrogen, hydrogen plasma, etc. For example, a dispersion of exfoliated graphite oxide in a carrier (such as water, organic solvents, or a mixture of solvents) can be made using any suitable method (such as ultrasonication and/or mechanical grinding or milling) and reduced to graphene sheets.

Graphite oxide may be produced by any method known in the art, such as by a process that involves oxidation of graphite using one or more chemical oxidizing agents and, optionally, intercalating agents such as sulfuric acid. Examples of oxidizing agents include nitric acid, sodium and potassium nitrates, perchlorates, hydrogen peroxide, sodium and potassium permanganates, phosphorus pentoxide, bisulfites, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite may also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets may display little or no signature corresponding to graphite or graphite oxide in their X-ray diffraction pattern.

The thermal exfoliation can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating may be done using a flash lamp.

During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

Examples of temperatures at which the thermal exfoliation of graphite oxide may be carried out are at least about 300° C., at least about 400° C., at least about 450° C., at least about 500° C., at least about 600° C., at least about 700° C., at least about 750° C., at least about 800° C., at least about 850° C., at least about 900° C., at least about 950° C., and at least about 1000° C. Preferred ranges include between about 750 about and 3000° C., between about 850 and 2500° C., between about 950 and about 2500° C., and between about 950 and about 1500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature may vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets may be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used may be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature may vary within these ranges.

The heating may be done under a variety of conditions, including in an inert atmosphere (such as argon or nitrogen) or a reducing atmosphere, such as hydrogen (including hydrogen diluted in an inert gas such as argon or nitrogen), or under vacuum. The heating may be done in any appropriate vessel, such as a fused silica or a mineral or ceramic vessel or a metal vessel. The materials being heated including any starting materials and any products or intermediates) may be contained in an essentially constant location in single batch reaction vessel, or may be transported through one or more vessels during the reaction in a continuous or batch reaction. Heating may be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 700 m²/g. The surface area may be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets may have a bulk density of from about 0.1 to at least about 200 kg/m³. The bulk density includes all values and subvalues therebetween, especially including 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (0/0 ratio), as determined by elemental analysis of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks due to the presence of lattice defects in the honeycomb structure of the graphite basal plane. These kinks can be desirable to prevent the stacking of the single sheets back to graphite oxide and/or other graphite structures under the influence of van der Waals forces.

In one embodiment, the composition further comprises graphite, wherein the ratio by weight of graphite to graphene sheets may be from about 2:98 to about 98:2, or from about 5:95 to about 95:5, or from about 10:90 to about 90:10, or from about 20:80 to about 80:20, or from about 30:70 to 70:30, or from about 40:60 to about 90:10, or from about 50:50 to about 85:15, or from about 60:40 to about 85:15, or from about 70:30 to about 85:15.The graphene sheets (or graphene sheets and graphite, if used) can be present in about 1 to about 98 weight percent, about 5 to about 98 weight percent, about 10 to about 98 weight, about 20 to about 98 weight percent, in about 30 to about 95 weight percent, in about 40 to about 95 weight percent, in about 50 to about 95 weight percent, and in about 70 to about 95 weight percent, based on the total amount of graphene sheets (or graphene sheets and graphite, if used) and olefin polymer.

The graphene sheets may comprise two or more graphene powders having different particle size distributions and/or morphologies. If present, the graphite may also comprise two or more graphite powders having different particle size distributions and/or morphologies.

The compositions may optionally comprise at least one “multi-chain lipid”, by which term is meant a naturally-occurring or synthetic lipid having a polar head group and at least two nonpolar tail groups connected thereto. Examples of polar head groups include oxygen-, sulfur-, and halogen-containing, phosphates, amides, ammonium groups, amino acids (including α-amino acids), saccharides, polysaccharides, esters (Including glyceryl esters), zwitterionic groups, etc.

The tail groups may the same or different. Examples of tail groups include alkanes, alkenes, alkynes, aromatic compounds, etc. They may be hydrocarbons, functionalized hydrocarbons, etc. The tail groups may be saturated or unsaturated. They may be linear or branched. The tail groups may be derived from fatty acids, such as oleic acid, palmitic acid, stearic acid, arachidic acid, erucic acid, arachadonic acid, linoleic acid, linolenic acid, oleic acid, etc.

Examples of multi-chain lipids include, but are not limited to, lecithin and other phospholipids (such as phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; sphingolipids (such as ceramides, di- and triglycerides, phosphosphingolipids, and glycosphingolipids); etc. They may be amphoteric, including zwitterionic.

The compositions may optionally comprise one or more charged organic compounds. The charged organic compound comprises at least one ionic functional group and one hydrocarbon-based chain. Examples of ionic functional groups include ammonium salts, sulfates, sulphonates, phosphates, carboxylates, etc. If two or more ionic functional groups are present, they may be of the same or different types. The compound may comprise additional functional groups, including, but not limited to hydroxyls, alkenes, alkynes, carbonyl groups (such as carboxylic acids, esters, amides, ketones, aldehydes, anhydrides, thiol, etc.), ethers, fluoro, chloro, bromo, iodo, nitriles, nitrogen containing groups, phosphorous containing groups, silicon containing groups, etc.

The compound comprises at least one hydrocarbon-based chain. The hydrocarbon-based chain may be saturated or unsaturated and may be branched or linear. It may be an alkyl group, alkenyl group, alkynyl group, etc. It need not contain only carbon and hydrogen atoms. It may be substituted with other functional groups (such as those mentioned above). Other functional groups, such as esters, ethers, amides, may be present in the length of the chain. In other words, the chain may contain two or more hydrocarbon-based segments that are connected by one or more functional groups. In one embodiment, at least one ionic functional group is located at the end of a chain.

Examples of ammonium salts include materials having the formula: R¹R²R³R⁴N⁺X⁻, where R¹, R², and R³, are each independently H, a hydrocarbon-based chain, an aryl-containing group, an alicyclic group; an oligomeric group, a polymeric group, etc.; where R⁴ is a hydrocarbon-based chain having at least four carbon atoms; and where X⁻ is an anion such as fluoride, bromide, chloride, iodide, sulfate, hydroxide, carboxylate, etc. Any of the R groups may have one or more additional ammonium groups.

Examples of R groups include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, C₂₁ to C₄₀ chains, etc.

Examples of quaternary ammonium salts include tetraalkylammonium salts, dialkyldimethylammonium salts, alkyltrimethylammonium salts, where the alkyl groups are one or more groups containing at least eight carbon atoms. Examples include tetradodecylammonium, tetradecyltrimethylammonium halide, hexadecyltrimethylammonium halide, didodecyldimethylammonium halide, etc.

Ammonium salts may be bis- or higher order ammonium salts, including quaternary ammonium salts. They may be salts of carboxylic acids, dicarboxylic acids, tricarboxylic acids, and higher carboxylic acids. The carboxylic acids may have be part of a hydrocarbon-based chain having at least about four linear carbon atoms. Examples include ammonium salts of octanoic acid, nonanoic acid, decanoic acid, undecanoic acid, dodecanoic acid, tridecanoic acid, tetradecanoic acid, pentadecanic acid, carboxylic acids having at least 15 carbon atoms, stearic acid, oleic acid, montanic acid, apidic acid, 1,7-heptanedioic acid, 1,8-octandioic acid, 1,9-nonanedioic acid, sebacic acid, 1,11-undecandioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, 1,18-octadecanedioic acid, 1,19-nonadecanedioic acid, 1,20-eicosanedioic acid, dicarboxylic acids having 21 to 40 carbon atoms, etc.

Alkylol ammonium salts of carboxylic acids (including high molecular weight carboxylic acids and unsaturated carboxylic acids) may be used. Examples include EFKA 5071, an alkylol ammonium salt of a high-molecular weight carboxylic acid supplied by Ciba and BYK-ES80, an alkylolammonium salt of an unsaturated acidic carboxylic acid ester manufactured by BYK USA, Wallingford, Conn.

The charged organic compound may have a sulfur containing group such as a sulphonate, mesylate, triflate, tosylate, besylate, sulfates, sulfite, peroxomonosulfate, peroxodisulfate, pyrosulfate, dithionate, metabisulfite, dithionite, thiosulfate, tetrathionate, etc. The organic compound may also contain two or more sulfur containing groups.

Alkyl, alkenyl, and/or alkynyl sulfates and sulphonates are preferred sulfur-containing compounds. The alkyl, alkenyl, and/or alkynyl groups preferably contain at least about 8 carbon atoms, or more preferably at least about 10 carbon atoms. Examples include decylsulfate salts, dodecylsulfate salts (such as sodium 1-dodecanesulfate (SDS)), decylsulfonate salts, dodecylsulfonate salts (such as sodium 1-dodecanesulfonate (SDSO)), etc. The counter ions may be any suitable cations, such as lithium, sodium, potassium, ammonium, etc.

The charged organic compound may be present in about 1 to about 75 weight percent, in about 2 to about 70 weight percent, in about 2 to about 60 weight percent, in about 2 to about 50 weight percent, in about 5 to about 50 weight percent, in about 10 to about 50 weight percent, in about 10 to about 40 weight percent, in about 20 to about 40 weight percent, based on the total weight of charged organic compound and graphene sheets (or graphene sheets and graphite, if used)).

The compositions may optionally contain additional electrically conductive components other than the graphene sheets or graphene sheets and graphite if used, such as metals (including metal alloys), conductive metal oxides, polymers, carbonaceous materials other than graphene sheets or graphene sheets and graphite if used, metal-coated materials, etc. These components can take a variety of forms, including particles, powders, flakes, foils, needles, etc.

Examples of metals include, but are not limited to silver, copper, aluminum, platinum, palladium, nickel, chromium, gold, bronze, colloidal metals, etc. Examples of metal oxides include antimony tin oxide and indium tin oxide and materials such as fillers coated with metal oxides. Metal and metal-oxide coated materials include, but are not limited to metal coated carbon and graphite fibers, metal coated glass fibers, metal coated glass beads, metal coated ceramic materials (such as beads), etc. These materials can be coated with a variety of metals, including nickel.

Examples of electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), copolymers of one or more of the foregoing, etc., and their derivatives and copolymers. The conductive polymers may be doped or undoped. They may be doped with boron, phosphorous, iodine, etc.

Examples of carbonaceous materials include, but are not limited to, graphite (including natural, Kish, synthetic, annealed, pyrolytic, highly oriented pyrolytic, etc. graphites), graphitized carbon, carbon black, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, carbon foams, etc.

The compositions may comprise additional additives, such as flame retardants, plasticizers, antioxidants, UV stabilizers, heat stabilizers, lubricants, processing aids, mold release agents, colorants, etc.

The compositions can be electrically conductive. They can have a conductivity of at least about 10⁻⁸ S/m. It can can have a conductivity of about 10⁻⁶ S/m to about 10⁵ S/m, or of about 10⁻⁵ S/m to about 10⁵ S/m. In other embodiments of the invention, the compositions have conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m. In some embodiments, the surface resistivity of the coated substrate may be no greater than about 10000 Ω/square, or no greater than about 5000 Ω/square, or no greater than about 1000 Ω/square or no greater than about 700 Ω/square, or no greater than about 500 Ω/square, or no greater than about 350 Ω/square, or no greater than about 200 Ω/square, or no greater than about 200 Ω/square, or no greater than about 150 Ω/square, or no greater than about 100 Ω/square, or no greater than about 75 Ω/square, or no greater than about 50 Ω/square, or no greater than about 30 Ω/square, or no greater than about 20 Ω/square, or no greater than about 10 Ω/square, or no greater than about 5 Ω/square, or no greater than about 1 Ω/square, or no greater than about 0.1 Ω/square, or no greater than about 0.01 Ω/square, or no greater than about 0.001 Ω/square. Electrical conductivities or resistivities can be determined before or after the composition is crosslinked.

The compositions can have a thermal conductivity of about 0.1 to about 50 W/(m-K), or of about 0.5 to about 30 W/(m-K), or of about 1 to about 30 W/(m-K), or of about 1 to about 20 W/(m-K), or of about 1 to about 10 W/(m-K), or of about 1 to about 5 W/(m-K), or of about 2 to about 25 W/(m-K), or of about 5 to about 25 W/(m-K). Thermal conductivities can be determined before or after the composition is crosslinked.

The compositions may take on a variety of forms. They may be polymeric resins, composites, etc. (including molding and extrusion materials); molded articles; extruded articles; liquid suspensions or dispersions; pastes, powders; films; coatings (including inks); filaments; fibers; etc.

The compositions may be well-mixed blends in which the graphene sheets are dispersed in the polymer. They may be formed using any means known in the art. When the polymer is one or more thermoplastics, they may be made using any suitable melt-mixing method, such as using a single or twin-screw extruder, a blender, a kneader, or a Banbury mixer. In one embodiment of the invention, the compositions are melt-mixed blends wherein the non-polymeric ingredients are well-dispersed in the polymer matrix, such that the blend forms a unified whole.

The compositions may be formed by polymerizing monomers in the presence of the graphene sheets and/or other components.

The compositions may be formed into articles using any suitable technique, including compression molding, extrusion, ram extrusion, injection molding, extrusion, co-extrusion, rotational molding, blow molding, injection blow molding, thermoforming, vacuum forming, casting, solution casting, centrifugal casting, overmolding, resin transfer molding, vacuum assisted resin transfer molding, spinning, printing, etc. When melt-processing techniques are used, the compositions are preferably melt-blended mixtures.

The compositions may be in the form of coatings. By the term “coating” is meant a composition that is in a form that is suitable for application to a substrate as well as the material after it is applied to the substrate, while it is being applied to the substrate, and both before and after any post-application treatments (such as evaporation, cross-linking, curing, etc.). The components of the coating compositions may vary during these stages. As used here, the term “coating” can refer to an ink.

The graphene sheets (or graphene sheets and graphite, if used) are preferably present in the coatings in about 5 to about 98 weight percent, in about 10 to about 95 weight percent, in about 20 to about 95 weight percent, in about 30 to about 95 weight percent, in about 40 to about 95 weight percent, in about 50 to about 95 weight percent, and in about 70 to about 95 weight percent, based on the total amount of graphene sheets (or graphene sheets and graphite, if used), and olefin polymer. The coatings may be made using any suitable method, including wet or dry methods and batch, semi-continuous, and continuous methods.

For example, components of the coatings, such as one or more of the graphene sheets, olefin polymer, carriers, and/or other components may be processed (e.g. milled, ground, blended, etc.) by using suitable mixing, dispersing, and/or compounding techniques and apparatus, including ultrasonic devices, high-shear mixers, two-roll mills, three-roll mills, cryogenic grinding crushers, extruders, kneaders, double planetary mixers, triple planetary mixers, high pressure homogenizers, ball mills, attrition equipment, sandmills, and horizontal and vertical wet grinding mills, etc.

The resulting blends may be further processed by grinding using wet or dry grinding technologies. The technologies can be continuous or discontinuous. Examples include ball mills, attrition equipment, sandmills, and horizontal and vertical wet grinding mills. Suitable materials for use as grinding media include metals, carbon steel, stainless steel, ceramics, stabilized ceramic media (such as yttrium stabilized zirconium oxide), PTFE, glass, tungsten carbide, etc.

Methods such as these can be used to change the particle size and/or morphology of the graphite, graphene sheets (if used), other components, and blends or two or more components.

Components may be processed together or separately and may go through multiple processing (including mixing/blending) stages, each involving one or more components (including blends).

There is no particular limitation to the way in which the graphene sheets, graphite, and other components are processed and combined. For example, graphene sheets and/or graphite may be processed into given particle size distributions and/or morphologies separately and then combined for further processing with or without the presence of additional components. Unprocessed graphene sheets and/or graphite may be combined with processed graphene sheets and/or graphite and further processed with or without the presence of additional components. Processed and/or unprocessed graphene sheets and/or processed and/or unprocessed graphite may be combined with other components, such as one or more binders and then combined with processed and/or unprocessed graphene sheets and/or processed and/or unprocessed graphite. Two or more combinations of processed and/or unprocessed graphene sheets and/or processed and/or unprocessed graphite that have been combined with other components may be further combined or processed.

In one embodiment, if a multi-chain lipid is used, it is added to graphene sheets and/or graphite before processing.

After processing (such as blending and/or grinding steps), additional components may be added to the coatings, including, but not limited to, binders, thickeners, viscosity modifiers, etc. The coatings may also be diluted by the addition of more carrier.

When a charged organic compound is used in a coating, the graphene sheets and graphite are preferably subjected to one or more grinding steps in the presence of a carrier prior to the addition of the charged organic compound to the composition. The olefin polymer may be added at any point in the process (or at two or more points).

The coatings optionally comprise one or more carriers in which some or all of the components are dissolved, suspended, or otherwise dispersed or carried. Examples of suitable carriers include, but are not limited to, water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), imides, amides (such as dimethyl formamide, dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)). and mixtures of two or more of the foregoing and mixtures of one or more of the foregoing with other carriers. Solvents may be low- or non-VOC solvents, non-hazardous air pollution solvents, and non-halogenated solvents.

The coatings may optionally comprise one or more additional additives, such as dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, etc.

Examples of dispersing aids include glycol ethers (such as poly(ethylene oxide)), block copolymers derived from ethylene oxide and propylene oxide (such as those sold under the trade name Pluronic® by BASF), acetylenic diols (such as 2,5,8,11-tetramethyl-6-dodecyn-5,8-diol ethoxylate and others sold by Air Products under the trade names Surfynol® and Dynol®), salts of carboxylic acids (including alkali metal and ammonium salts), and polysiloxanes.

Examples of grinding aids include stearates (such as Al, Ca, Mg, and Zn stearates) and acetylenic diols (such as those sold by Air Products under the trade names Surfynol® and Dynol®).

Examples of adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and others sold by Johnson-Matthey Catalysts under the trade name Vertec®.

Examples of thickening agents include glycol ethers (such as poly(ethylene oxide), block copolymers derived from ethylene oxide and propylene oxide (such as those sold under the trade name Pluronic® by BASF), long-chain carboxylate salts (such aluminum, calcium, zinc, etc. salts of stearates, oleats, palmitates, etc.), aluminosilicates (such as those sold under the Minex® name by Unimin Specialty Minerals and Aerosil® 9200 by Evonik Degussa), fumed silica, natural and synthetic zeolites, etc.

The coatings may be applied to a wide variety of substrates, including, but not limited to, flexible and/or stretchable materials, silicones and other elastomers and other polymeric materials, metals (such as aluminum, copper, steel, stainless steel, etc.), adhesives, fabrics (including cloths) and textiles (such as cotton, wool, polyesters, rayon, etc.), clothing, glasses and other minerals, ceramics, silicon surfaces, wood, paper, cardboard, paperboard, cellulose-based materials, glassine, labels, silicon and other semiconductors, laminates, corrugated materials, concrete, bricks, and other building materials, etc. Substrates may in the form of films, papers, wafers, larger three-dimensional objects, etc.

The substrates may have been treated with other materials such as coatings (such as paints) or similar materials before the coatings are applied. Examples include substrates (such as PET) coated with indium tin oxide, antimony tin oxide, etc. They may be woven, nonwoven, in mesh form; etc. They may be woven, nonwoven, in mesh form; etc.

The substrates may be paper-based materials generally (including paper, paperboard, cardboard, glassine, etc.). Paper-based materials can be surface treated. Examples of surface treatments include coatings such as polymeric coatings, which can include PET, polyethylene, polypropylene, acetates, nitrocellulose, etc. Coatings may be adhesives. The paper based materials may be sized.

Examples of polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid), etc).; polystyrene; polyamides (including polyterephthalamides); polyimides (such as Kapton®); aramids (such as Kevler° and Nomex®); fluoropolymers (such as fluorinated ethylene propylene (FEP), polytetrafluoroethylene (PTFE), poly(vinyl fluoride), poly(vinylidene fluoride), etc.); polyetherimides; poly(vinyl chloride); poly(vinylidene chloride); polyurethanes (such as thermoplastic polyurethanes (TPU)); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); Mylar; etc. They may be non-woven materials, such as DuPont Tyvek®. They may be adhesive materials.

The substrate may be a transparent or translucent or optical material, such as glass, quartz, polymer (such as polycarbonate or poly(meth)acrylates (such as poly(methyl methacrylate).

The coatings may be applied to the substrate using any suitable method, including, but not limited to, painting, pouring, spin casting, solution casting, dip coating, powder coating, lamination, extrusion, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, capillary printing, offset printing, electrohydrodynamic (EHD) printing (a method of which is described in WO 2007/053621, which is hereby incorporated herein by reference), flexographic printing, pad printing, stamping, xerography, microcontact printing, dip pen nanolithography, laser printing, via pen or similar means, etc. The coatings can be applied in multiple layers.

When applied to a substrate, the coatings can have a variety of thicknesses. In one embodiment, when applied to a substrate, after curing the coating can optionally have a thickness of at least about 2 nm, or at least about 5 nm. In various embodiments, the coatings can optionally have a thickness of about 2 nm to 2 mm, about 5 nm to 1 mm, about 2 nm to about 100 nm, about 2 nm to about 200 nm, about 2 nm to about 500 nm, about 2 nm to about 1 micrometer, about 5 nm to about 200 nm, about 5 nm to about 500 nm, about 5 nm to about 1 micrometer, about 5 nm to about 50 micrometers, about 5 nm to about 200 micrometers, about 10 nm to about 200 nm, about 50 nm to about 500 nm, about 50 nm to about 1 micrometer, about 100 nm to about 10 micrometers, about 1 micrometer to about 2 mm, about 1 micrometer to about 1 mm, about 1 micrometer to about 500 micrometers, about 1 micrometer to about 200 micrometers, about 1 micrometer to about 100 micrometers, about 50 micrometers to about 1 mm, about 100 micrometers to about 2 mm, about 100 micrometers to about 1 mm, about 100 micrometers to about 750 micrometers, about 100 micrometers to about 500 micrometers, about 500 micrometers to about 2 mm, or about 500 micrometers to about 1 mm.

When applied to a substrate, the coatings can have a variety of forms. They can be present as a film or lines, patterns, letters, numbers, circuitry, logos, identification tags, and other shapes and forms. The coatings may be covered in whole and or in part with additional material, such as overcoatings, varnishes, polymers, fabrics, etc.

The coatings can be applied to the same substrate in varying thicknesses at different points and can be used to build up three-dimensional structures on the substrate.

The compositions may be used in applications requiring electrical conductivity, static dissipativity, electromagnetic interference shielding properties, etc., including when these properties are needed along with properties such as barrier properties, moisture resistance, etc.

Examples of articles made at least in part from the compositions include fuel system components (such as fuel lines and tubing, fuel tank filler pipes and connectors, fuel line connectors, fuel pumps, fuel pump and delivery module components, fuel injector components, and fuel filter housings, fuel line grounding clips, fuel tank flanges, fuel filter clamps, fuel tank caps, and components comprising heat dissipation elements, such as heat sink fins, fuel tanks); automotive components such as electrical and electronic system connectors and housings, body panels and other body components; airplane components; pipes and tubes; seals; gaskets; electrical and electronic switches, connectors, housings, etc.; heat sinks; circuit board housings; contacts; antennas; electrodes; battery and ultracapacitor components; sensor components and housings; electronic devices housings (such as for televisions, computer equipment, video game systems, displays, portable electronic devices (such as cellular telephones, GPS receivers, music players, computers, game devices, etc.); rubber goods; tires; tanks and bottles (such as gas and liquid tanks, cryotanks, pressure vessels, etc.); etc.

The coatings can be used for the passivation and corrosion protection of surfaces, such as metal (e.g. steel, aluminum, etc.) surfaces, including exterior structures such as bridges and buildings. Examples of other uses of the coatings include: UV radiation resistant coatings, abrasion resistant coatings, coatings having permeation resistance to liquids (such as hydrocarbon, alcohols, water, etc.) and/or gases, electrically conductive coatings, static dissipative coatings, and blast and impact resistant coatings. They can be used to make fabrics having electrical conductivity. The coatings can be used in solar cell applications; solar energy capture applications; ignage, flat panel displays; flexible displays, including light-emitting diode, organic light-emitting diode, and polymer light-emitting diode displays; backplanes and frontplanes for displays; and lighting, including electroluminescent and OLED lighting. The displays may be used as components of portable electronic devices, such as computers, cellular telephones, games, GPS receivers, personal digital assistants, music players, games, calculators, artificial “paper” and reading devices, etc.

They may be used in packaging and/or to make labels. They may be used in inventory control and anti-counterfeiting applications (such as for pharmaceuticals), including package labels. They may be used to make smart packaging and labels (such as for marketing and advertisement, information gathering, inventory control, information display, etc.). They may be used to form a Faraday cage in packaging, such as for electronic components.

The coatings can be used on electrical and electronic devices and components, such as housings etc, to provide EMI shielding properties. They made be used in microdevices (such as microelectromechanical systems (MEMS) devices) including to provide antistatic coatings.

They may be used in the manufacture of housings, antennas, and other components of portable electronic devices, such as computers, cellular telephones, games, navigation systems, personal digital assistants, music players, games, calculators, radios, artificial “paper” and reading devices, etc.

The coatings can be used to form thermally conductive channels on substrates or to form membranes having desired flow properties and porosities. Such materials could have highly variable and tunable porosities and porosity gradients can be formed. The coatings can be used to form articles having anisotropic thermal and/or electrical conductivities. The coatings can be used to form three-dimensional printed prototypes.

The coatings can be used to make printed electronic devices (also referred to as “printed electronics) that may be in the form of complete devices, parts or sub elements of devices, electronic components, etc.

Printed electronics may be prepared by applying the coating to a substrate in a pattern comprising an electrically conductive pathway designed to achieve the desired electronic device. The pathway may be solid, mostly solid, in a liquid or gel form, etc.

The printed electronic devices may take on a wide variety of forms and be used in a large array of applications. They may contain multiple layers of electronic components (e.g. circuits) and/or substrates. All or part of the printed layer(s) may be covered or coated with another material such as a cover coat, varnish, cover layer, cover films, dielectric coatings, electrolytes and other electrically conductive materials, etc. There may also be one or more materials between the substrate and printed circuits. Layers may include semiconductors, metal foils, dielectric materials, etc.

The printed electronics may further comprise additional components, such as processors, memory chips, other microchips, batteries, resistors, diodes, capacitors, transistors, etc.

Other applications include but are not limited to: passive and active devices and components; electrical and electronic circuitry, integrated circuits; flexible printed circuit boards; transistors; field-effect transistors; microelectromechanical systems (MEMS) devices; microwave circuits; antennas; diffraction gratings; indicators; chipless tags (e.g. for theft deterrence from stores, libraries, etc.); security and theft deterrence devices for retail, library, and other settings; key pads; smart cards; sensors; liquid crystalline displays (LCDs); signage; lighting; flat panel displays; flexible displays, including light-emitting diode, organic light-emitting diode, and polymer light-emitting diode displays; backplanes and frontplanes for displays; electroluminescent and OLED lighting; photovoltaic devices, including backplanes; product identifying chips and devices; membrane switches; batteries, including thin film batteries; electrodes; indicators; printed circuits in portable electronic devices (for example, cellular telephones, computers, personal digital assistants, global positioning system devices, music players, games, calculators, etc.); electronic connections made through hinges or other movable/bendable junctions in electronic devices such as cellular telephones, portable computers, folding keyboards, etc.); wearable electronics; and circuits in vehicles, medical devices, diagnostic devices, instruments, etc.

The electronic devices may be radiofrequency identification (RFID) devices and/or components thereof and/or radiofrequency communication device. Examples include, but are not limited to, RFID tags, chips, and antennas. The RFID devices may be ultrahigh frequency RFID devices, which typically operate at frequencies in the range of about 868 to about 928 MHz. Examples of uses for RFIDs are for tracking shipping containers, products in stores, products in transit, and parts used in manufacturing processes; passports; barcode replacement applications; inventory control applications; pet identification; livestock control; contactless smart cards; automobile key fobs; etc.

The electronic devices may also be elastomeric (such as silicone) contact pads and keyboards. Such devices can be used in portable electronic devices, such as calculators, cellular telephones, GPS devices, keyboards, music players, games, etc. They may also be used in myriad other electronic applications, such as remote controls, touch screens, automotive buttons and switches, etc.

### EXAMPLES

### Preparation of Test Samples

The coatings in the form of liquid dispersions are printed onto a substrate. The compositions of Example 1 are printed using a doctor blade. The compositions of the other examples and comparative examples are printed using a #28, 50 μm wire rod. The printed substrates are placed wet in an oven at 135° C. and cured for 1 hour.

In the case of Comparative Example 1 and Examples 1-11, the substrate is a silicone sheet. In the case of Comparative Example 2 and Examples 12-17, the substrate is a sheet of thermally stabilized poly(ethylene terephthalate) (PET).

### Conductivity Measurements

Electrical conductivity is determined using a four-point probe method. A rectangular four-point probe is placed on a sample. A potential difference (about 5-20 V) is applied across the sample and the current (I) is monitored with a multimeter. Another multimeter is used to measure the voltage (V) across two points having a known separation along the direction of the current.

The resistance is measured using Ohm's law, i.e. R=V/I; where R, V, and I are the resistance, voltage, and current, respectively. Resistivity (σ) is found by the equation σ=RA/L, where A and L are the cross sectional area of the film through which current flows and the length over which the potential difference is measured, respectively. Conductivity (κ) is found by the equation κ=1/σ. A is calculated by using the measured thickness of the sample. In some cases more than one measurement is made and the results are averaged. The results are given in the tables.

### Peel Resistance

The films are tested for resistance to peeling by firmly applying a piece of 3M Scotch® tape 232 to a portion of a printed film that includes at least one edge of the film. The tape is pulled off the film rapidly and the adhesive underside of the tape is checked for peeling. The peel resistance of the film is assessed as follows: excellent is no transfer of film to the tape; very good is a few small spots of film scattered on the surface of the tape; good is a number of small spots of film on the tape; fair is a thin layer of film or a large chunk of film on the tape; poor is separation of the film from the substrate or removal of a large of a large portion of the film. In some cases no cohesive film adhered to the substrate is formed.

### Ingredients

Graphene 90 refers to graphene sheets having a carbon to oxygen molar ratio of approximately 90:1.
Graphene 100 refers to graphene sheets having a carbon to oxygen molar ratio of approximately 100:1.
Graphene 130 refers to graphene sheets having a carbon to oxygen molar ratio of approximately 130:1.
Synthetic graphite refers to APS graphite supplied by Asbury Carbons, Asbury, N.J.
Electron refers to a citrus terpene-based solvent manufactured by Ecolink, Tucker, Ga.
Ammonium salt refers to BYK-ES80, an alkylolammonium salt of an unsaturated acidic carboxylic acid ester supplied in a butanol solution by BYK USA, Wallingford, Conn. The amounts used are about 33 weight percent (based on the actual amount of salt) relative to the total amount of salt and pigment.
Dispersant refers to DISPERBYK® 190, a solution of a high molecular weight block copolymer supplied by BYK USA, Wallingford, Conn.
E/AA refers to A-C® 5120, an ethylene/acrylic acid copolymer supplied by Honeywell.
EVA I refers to A-C® 400, an ethylene/vinyl acetate copolymer supplied by Honeywell.
E/AA II refers to A-C® 405T, an ethylene/vinyl acetate copolymer supplied by Honeywell.
P/MAH refers to A-C® 597P, a propylene/maleic anhydride copolymer supplied by Honeywell.
E/AA/MAH refers to Lotader0 8200, an ethylene/acrylic acid/maleic anhydride copolymer supplied by Arkema.
PVB refers to Mowital supplied by Kuraray America Inc.
S/AA refers to Joncry® 682, a styrene/acrylic acid copolymer supplied by BASF.
SEBS/MAH refers to Kraton® FG 1924, a styrene/ethylene/butadiene/styrene copolymer grafted with maleic anhydride supplied by Kraton.
DCP refers to dicumyl peroxide. The amounts given in the table are weight ratios relative to the amount of olefin polymer.

### Examples 2-4, 7-9, 11-13, and 17, and Comparative Example 1

Graphite is ground in isopropyl alcohol (IPA) in a vertical ball mill for about six hours using 3/16″ stainless steel balls. Graphene sheets having a C:O ratio of about 130:1 and dispersant are added and the mixture is ground for about six hours in the ball mill. The mixture is ground for about six hours in at about 20-25° C. in an Eiger Mini 250 Type M250-VSE-TEFV horizontal grinding mill using 0.3 mm of 5% yttrium stabilized zirconium oxide grinding media. The mixtures contain about 19.6 weight percent graphene sheets, about 78.4 weight percent graphite, and 2 weight percent dispersant.

The dispersion is then combined with the olefin polymer (the relative weight percentages of the graphene-graphite blends and olefin polymer(s) are given in the tables) dissolved in the carrier indicated in the tables, ammonium salt (if used), and dicumyl peroxide (if used) and blended in a high shear mixer (a homogenizer having a roto-stator overhead stirrer) operating at about 33,000 RPM for about three minutes.

The resulting dispersions are subsequently printed. In the case of each Example, a cohesive film is formed. In the case of Comparative Example 1, a flakey, non-cohesive film that has little to no adhesion to the substrate is formed.

### Examples 1, 5-6, 10, and 14-16

Graphene sheets are combined with the olefin polymer (the relative weight percentages of the graphene, olefin polymer(s), and any additional additives are given in the tables) and carrier indicated in the tables and ground for about six hours in a vertical ball mill using 3/16″ stainless steel balls. In the case of Examples 5 and 14, 1.9 weight percent dispersant is also present.

The resulting dispersion is combined with ammonium salt (if used) and dicumyl peroxide and blended in a high shear mixer (a homogenizer having a roto-stator overhead stirrer) operating at about 33,000 RPM for about three minutes.

The resulting dispersions are subsequently printed. In the case of each Example, a cohesive film is formed.

TABLE 1
(Silicone substrate)

| | Comp | | | | | |
|---|---|---|---|---|---|---|
| | Ex. 1 | Ex. 1 | Ex. 2 | Ex. 3 | Ex. 4 | Ex. 5 |
| Graphene 90 | — | 40 | — | — | — | — |
| Graphene 100 | — | — | — | — | — | 20 |
| Graphene- | 93 | — | 93 | 80 | 80 | — |
| graphite | | | | | | |
| E/AA | 7 | 60 | 7 | 20 | 10 | 26 |
| EVA I | — | — | — | — | 10 | — |
| EVA II | — | — | — | — | — | — |
| P/MAH | — | — | — | — | — | — |
| PVB | — | — | — | — | — | — |
| E/AA/MAH | — | — | — | — | — | — |
| S/AA | — | — | — | — | — | 52.2 |
| SEBS/MAH | — | — | — | — | — | — |
| Carrier | IPA | Electron | IPA | Electron | Electron | Electron |
| DCP (weight | — | 1:1 | 1:1 | 1:1 | 1:1 | 1:1 |
| ratio relative | | | | | | |
| to olefin | | | | | | |
| polymer) | | | | | | |
| Ammonium | — | — | — | Yes | yes | yes |
| salt | | | | | | |
| Conductivity | n/m | 3.5 | 87 | 21 | 52 | 4 |
| (S/cm) | | | | | | |
| Film thickness | n/m | 15 | 1.5 | 3 | 1 | 5 |
| (μm) | | | | | | |
| Peel resistance | — | — | — | good/ | fair | fair |
| | | | | fair | | |

“n/m” = not measured

TABLE 2
(Silicone substrate)

| | Ex. 6 | Ex. 7 | Ex. 8 | Ex. 9 | Ex. 10 | Ex. 11 |
|---|---|---|---|---|---|---|
| Graphene 90 | — | — | — | — | — | — |
| Graphene 100 | 30 | — | — | — | — | — |
| Graphene 130 | — | — | — | — | 30 | — |
| Graphene- | — | 93 | 93 | 93 | — | 80 |
| graphite | | | | | | |
| E/AA | 63 | — | — | — | — | — |
| EVA I | — | 7 | — | — | — | — |
| EVA II | — | — | 7 | — | — | — |
| P/MAH | — | — | — | 7 | — | — |
| PVB | — | — | — | — | — | 20 |
| E/AA/MAH | — | — | — | — | 70 | — |
| S/AA | — | — | — | — | — | — |
| SEBS/MAH | 7 | — | — | — | — | — |
| Carrier | Electron | IPA | IPA | IPA | Electron | Electron |
| DCP (weight | 1:1 | 1:1 | 1:1 | 1:1 | 1:1 | 1:1 |
| ratio relative | | | | | | |
| to olefin | | | | | | |
| polymer) | | | | | | |
| Ammonium | yes | yes | yes | yes | yes | yes |
| salt | | | | | | |
| Conductivity | 4.6 | 42 | 55 | 73 | 4.5 | 10 |
| (S/cm) | | | | | | |
| Film thickness | 2 | 1 | 1 | 1 | 4 | 4 |
| Peel resistance | excellent. | — | — | — | poor | poor |

TABLE 3
(PET substrate)

| | Ex. 12 | Ex. 13 | Ex. 14 | Ex. 15 | Ex. 16 | Ex. 17 |
|---|---|---|---|---|---|---|
| Graphene 100 | — | — | 20 | 30 | — | — |
| Graphene 130 | — | — | — | — | 30 | — |
| Graphene- | 80 | 80 | — | — | — | 80 |
| graphite | | | | | | |
| E/AA | 20 | 10 | 26 | 63 | — | — |
| EVA I | — | 10 | — | — | — | — |
| EVA II | — | — | — | — | — | — |
| P/MAH | — | — | — | — | — | — |
| PVB | — | — | — | — | — | 20 |
| E/AA/MAH | — | — | — | — | 70 | — |
| S/AA | — | — | 52.2 | — | — | — |
| SEBS/MAH | — | — | — | 7 | — | — |
| Carrier | Electron | Electron | Electron | Electron | Electron | Electron |
| DCP (weight | 1:1 | 1:1 | 1:1 | 1:1 | 1:1 | 1:1 |
| ratio relative | | | | | | |
| to olefin | | | | | | |
| polymer) | | | | | | |
| Conductivity | 63 | 188 | 6 | 7 | 6 | 59 |
| (S/cm) | | | | | | |
| Film thickness | 3 | 1 | 5 | 2 | 4 | 4 |
| Peel resistance | v. good | fair | good | v. good | poor | poor |

1. A composition, comprising graphene sheets, at least one olefin polymer, and at least one crosslinking agent.

2. The composition of claim 1, wherein the crosslinking agent is at least one peroxide.

3. The composition of claim 1, wherein the olefin polymer is one or more selected from the group consisting of poly(vinyl acetate), ethylene/vinyl acetate copolymers, poly(acrylic acid), ethylene/acrylic acid copolymers, polyvinyl alcohol, poly(vinyl butyral), and ionomers.

4. The composition of claim 1, further comprising graphite.

5. The composition of claim 4, wherein the ratio by weight of graphite to graphene sheets is from about 50:50 to about 95:5.

6. The composition of claim 1, wherein the graphene sheets have a surface area of at least about 300 m²/g.

7. The composition of claim 1 having an electrical conductivity of at least about 10 S/cm.

8. The composition of claim 1 in the form of a molding or extrusion resin

9. The composition of claim 1 in the form of a coating.

10. A composition, comprising graphene sheets and a crosslinked olefin polymer.

11. The composition of claim 10, wherein the olefin polymer has been crosslinked using a radical initiator.

12. The composition of claim 10, wherein the olefin polymer is one or more selected from the group consisting of poly(vinyl acetate), ethylene/vinyl acetate copolymers, poly(acrylic acid), ethylene/acrylic acid copolymers, polyvinyl alcohol, poly(vinyl butyral), and ionomers.

13. The composition of claim 10, further comprising graphite.

14. The composition of claim 10, wherein the graphene sheets have a surface area of at least about 300 m²/g.

15. The composition of claim 10 having an electrical conductivity of at least about 10 S/cm.

16. The composition of claim 10 in the form of a coating.

17. A method of making a composition, comprising crosslinking a composition comprising graphene sheets and at least substituted olefin polymer.

18. The method of claim 17, wherein the composition comprising graphene sheets and at least one substituted olefin polymer is applied to a substrate and subsequently crosslinked.

19. The method of claim 17, wherein a radical initiator is used to crosslink the composition.

20. The method of claim 17, further comprising graphite.
